(19) United States
(12) Patent Application Publication
(10) Pub. No.: US 2014/0307232 A1
(43) Pub. Date: Oct. 16, 2014

(54) PROJECTION-TYPE DISPLAY DEVICE AND METHOD FOR CONTROLLING PROJECTION-TYPE DISPLAY DEVICE

(71) Applicant: Sony Corporation, Tokyo (JP)

(72) Inventors: Yoshihisa Sato, Kanagawa (JP); Izushi Kobayashi, Tokyo (JP)

(73) Assignee: Sony Corporation, Tokyo (JP)

(21) Appl. No.: 14/245,633

(22) Filed: Apr. 4, 2014

(30) Foreign Application Priority Data
Apr. 11, 2013 (JP) 2013-082880

(51) Int. Cl. G03B 21/16; G03B 21/20

(52) U.S. Cl. CPC G03B 21/16; G03B 21/204
USPC 353/31; 353/57; 353/61; 353/121

(57) ABSTRACT

There is provided a projection-type display device including an excitation light source configured to emit excitation light, a fluorescent member configured to emit fluorescent light when the excitation light from the excitation light source is condensed, a heat sink connected to the excitation light source, a single air blowing fan configured to cool the heat sink and the fluorescent member together, and an excitation light source control unit configured to control an output of the excitation light source, depending on a luminance level of an external video signal.

### CROSS REFERENCE TO RELATED APPLICATIONS

This application claims the benefit of Japanese Priority Patent Application JP 2013-082880 filed Apr. 11, 2013, the entire contents of which are incorporated herein by reference.

### BACKGROUND

The present disclosure relates to projection-type display devices and methods for controlling the same.

In the related art, for example, JP 2012-18762A and JP 2011-197593A disclose a solid-state light source device technology for generating fluorescent light by illuminating a fluorescent member with excitation light, unlike a light source such as a discharge lamp which generates light by passing an electric discharge through a gas (e.g., mercury etc.) enclosed therein, and a projector device technology employing the same.

### SUMMARY

However, in the technologies described in JP 2012-18762A and JP 2011-197593A supra, while a laser diode which is a light source for emitting the excitation light is cooled, a fluorescent member is not cooled. In order to implement a light source which outputs light, it is necessary to cool not only the laser diode but also the fluorescent member. Also, in such a solid-state light source, if the output of the excitation light source is large, the excitation light source and the fluorescent member generate a large amount of heat, disadvantageously leading to a further increase in power consumption.

Therefore, there has been a demand for a technique of, when the excitation light source has a variable excitation light output, optimally cooling both the excitation light source and the fluorescent member using a simple structure. According to an embodiment of the present disclosure, there is provided a projection-type display device including an excitation light source configured to emit excitation light, a fluorescent member configured to emit fluorescent light when the excitation light from the excitation light source is condensed, a heat sink connected to the excitation light source, a single air blowing fan configured to cool the heat sink and the fluorescent member together, and an excitation light source control unit configured to control an output of the excitation light source, depending on a luminance level of an external video signal.

According to an embodiment of the present disclosure, the projection-type display device may further include an air blowing fan control unit configured to change an amount of air sent by the air blowing fan, depending on the output of the excitation light source.

According to an embodiment of the present disclosure, the projection-type display device may further include a duct configured to divide cooling air of the air blowing fan into portions which are sent to the heat sink and the fluorescent member.

According to an embodiment of the present disclosure, the excitation light source may include a plurality of laser diodes. The plurality of laser diodes may be arranged in a two-dimensional array on the heat sink, and cooling air from the air blowing fan may flow through the array from a longer side of the array in a direction along a shorter side of the array.

According to an embodiment of the present disclosure, the projection-type display device may further include a spatial light modulator configured to receive the fluorescent light.

According to an embodiment of the present disclosure, the projection-type display device may further include a spatial light modulator control unit configured to control drive of the spatial light modulator, depending on the output of the excitation light source.

According to an embodiment of the present disclosure, the projection-type display device may further include a light source configured to emit light having a wavelength different from a wavelength of the fluorescent light.

According to an embodiment of the present disclosure, the projection-type display device may emit the fluorescent light and the light having the wavelength different from the wavelength of the fluorescent light together.

According to an embodiment of the present disclosure, the light source may be connected to the heat sink.

According to an embodiment of the present disclosure, the projection-type display device may further include an excitation light condensing optical system configured to condense the excitation light from the excitation light source to a substantially identical portion of a surface of the fluorescent member.

According to an embodiment of the present disclosure, the projection-type display device may further include a fluorescent light condensing optical system configured to condense the fluorescent light emitted from the fluorescent member.

According to an embodiment of the present disclosure, the projection-type display device may further include a fluorescent light condensing optical system configured to condense the fluorescent light emitted from the fluorescent member. A portion of the excitation light condensing optical system may serve as a portion of the fluorescent light condensing optical system.

According to an embodiment of the present disclosure, the fluorescent light condensing optical system may condense the fluorescent light emitted from a surface of the fluorescent member on which the excitation light is condensed.

According to an embodiment of the present disclosure, there is provided a method for controlling a projection-type display device. The projection-type display device includes an excitation light source configured to emit excitation light, a fluorescent member configured to emit fluorescent light when the excitation light from the excitation light source is condensed, a heat sink connected to the excitation light source, and a single air blowing fan configured to cool the heat sink and the fluorescent member together. The method includes controlling an output of the excitation light source, depending on a luminance level of an external video signal, and controlling an amount of air sent by the air blowing fan, depending on the output of the excitation light source.

According to an embodiment of the present disclosure, when the excitation light source has a variable excitation light output, both the excitation light source and the fluorescent member can be optimally cooled using a simple structure.

### BRIEF DESCRIPTION OF THE DRAWINGS

FIG. 1 is a schematic diagram showing a structure of a light source device according to an embodiment of the present disclosure;

FIG. 2 is a schematic diagram showing a structure of a disc-shaped base plate on which a fluorescent member is provided;

FIG. 3 is a schematic diagram showing a structure of a projector device;

FIG. 4A is a schematic diagram showing a case where none of a light source device and an SLM is controlled based on an external video signal;

FIG. 4B is a schematic diagram showing a case where none of a light source device and an SLM is controlled based on an external video signal;

FIG. 5A is a schematic diagram showing a case where a light source device and an SLM are controlled based on an external video signal;

FIG. 5B is a schematic diagram showing a case where a light source device and an SLM are controlled based on an external video signal;

FIG. 6 is a schematic diagram showing a structure in which fluorescent light generated by excitation light condensed on the fluorescent member of the disc-shaped base plate is reflected toward an excitation light source, and then travels toward the excitation light source;

FIG. 7 is a schematic diagram showing a variation of the structure of FIG. 6 in which a lens is provided between the disc-shaped base plate and a separation mirror;

FIG. 8 is a schematic diagram showing a variation of the structure of FIG. 7 in which a blue light source is additionally provided as a second light source;

FIG. 9 is a schematic diagram showing a variation of the structure of FIG. 8 in which, as with the excitation light source, a blue light source is connected to a heat sink; and

FIG. 10 is a schematic diagram showing a structure of the heat sink.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be given in the following order.

1. Example Structure of Light Source Device

2. Example Structure of Projector Device

3. Control of Light Source Device and SLM

4. Other Example Structures of Light Source Device

[1. Example Structure of Light Source Device]

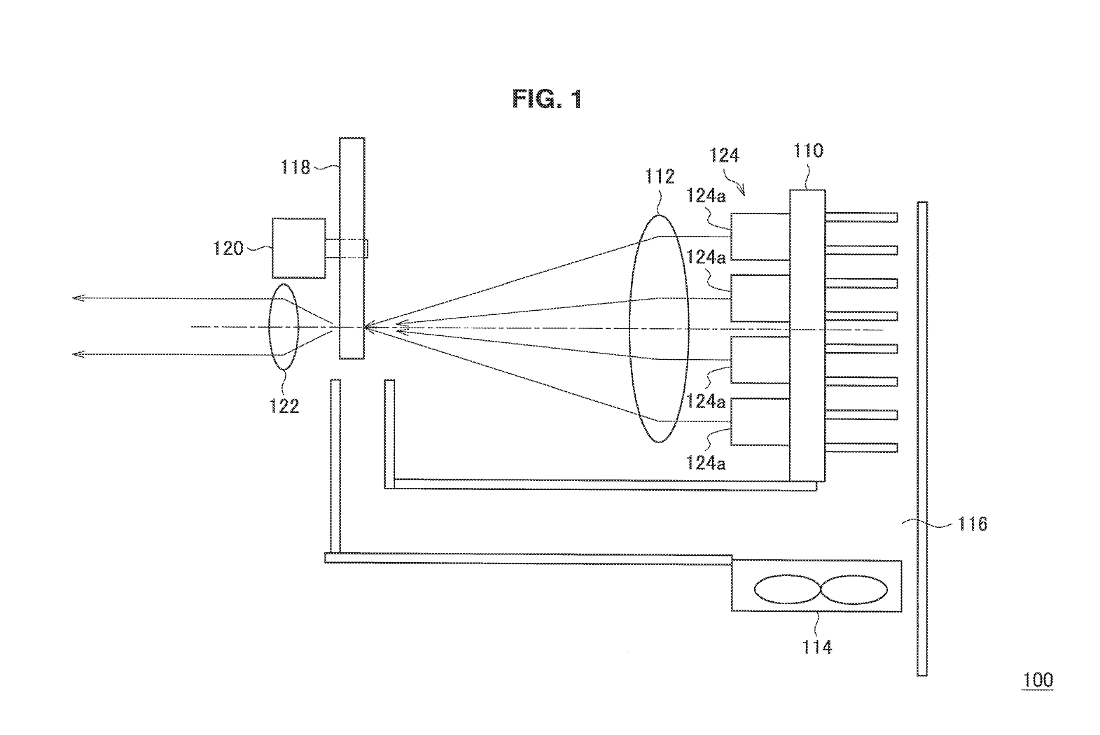

Firstly, a structure of a light source device 100 according to this embodiment will be described with reference to FIG. 1. The light source device 100 is used as a light source for a projection-type display device (projector device) 500 according to this embodiment. FIG. 1 is a schematic diagram showing the structure of the light source device 100. As shown in FIG. 1, the device 100 includes a heat sink 110, an excitation light condensing lens 112, an air blowing fan 114, an air duct 116, a disc-shaped base plate 118, a motor 120, a fluorescent light condensing lens 122, and an excitation light source 124. The excitation light source 124, which includes a plurality of laser diodes 124a which output excitation light having a wavelength band of 440 nm to 480 nm, is connected to the heat sink 110. The laser diodes 124a are arranged in an array on the heat sink 110. The excitation light from the excitation light source 124 is condensed by the excitation light condensing lens 112 to a point on a surface of a fluorescent member 118a which is provided on a surface of the disc-shaped base plate 118.

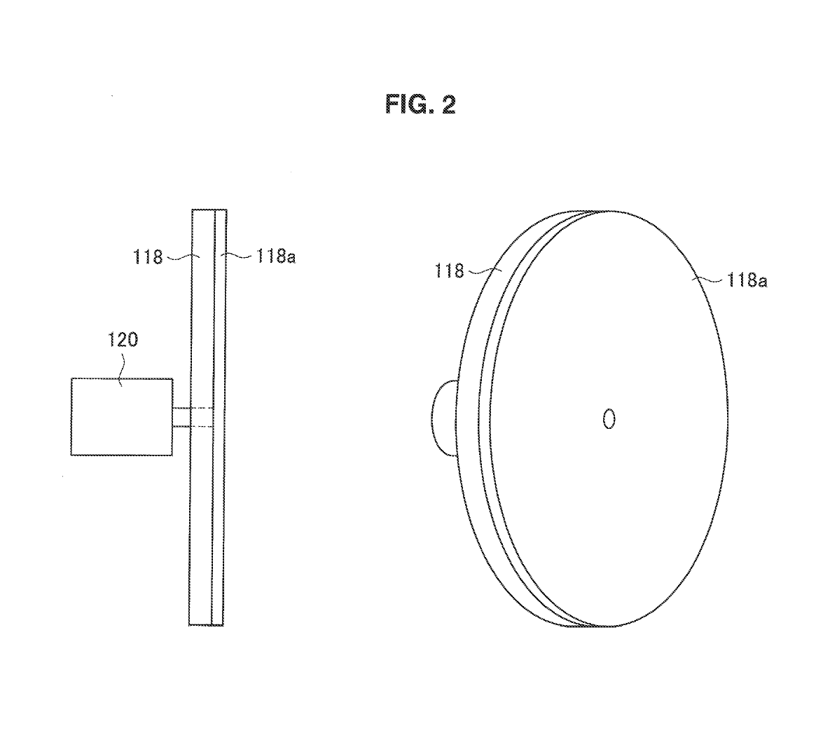

As shown in FIG. 2, the fluorescent member 118a is provided on the disc-shaped base plate 118. The disc-shaped base plate 118 includes, for example, a glass plate. The motor 120 is connected to the disc-shaped base plate 118. The disc-shaped base plate 118 is driven by the motor 120 to rotate. The excitation light condensed on the fluorescent member 118a excites the fluorescent member 118a, which then outputs fluorescent light. The fluorescent light is condensed by the fluorescent light condensing lens 122 which is located behind the disc-shaped base plate 118.

The light source device 100 includes the air blowing fan 114. Cooling air sent by the air blowing fan 114 is introduced through the air duct 116 to the heat sink 110 and the disc-shaped base plate 118 on which the fluorescent member 118a is provided. Therefore, the excitation light source 124 and the disc-shaped base plate 118 can be cooled substantially invariably at substantially the same rate by the cooling air sent by the single air blowing fan 114.

The excitation light is condensed to a point on the surface of the fluorescent member 118a. Because the power of the excitation light is high, the surface of the fluorescent member 118a is heated. Therefore, the disc-shaped base plate 118 and the fluorescent member 118a are cooled by the cooling air while the disc-shaped base plate 118 is driven by the motor 120 to rotate so that the position where the excitation light is condensed is moved.

If the excitation light from the excitation light source 124 is strong, the excitation light source 124 generates a large amount of heat, and the fluorescent member 118a also generates a large amount of heat. The amount of heat generated by the excitation light source 124 is proportional to the amount of heat generated by the fluorescent member 118a. Therefore, by cooling the excitation light source 124 and the disc-shaped base plate 118 substantially invariably at substantially the same rate using the single air blowing fan 114, the excitation light source 124 and the disc-shaped base plate 118 can each be moderately cooled.

[2. Example Structure of Projector Device]

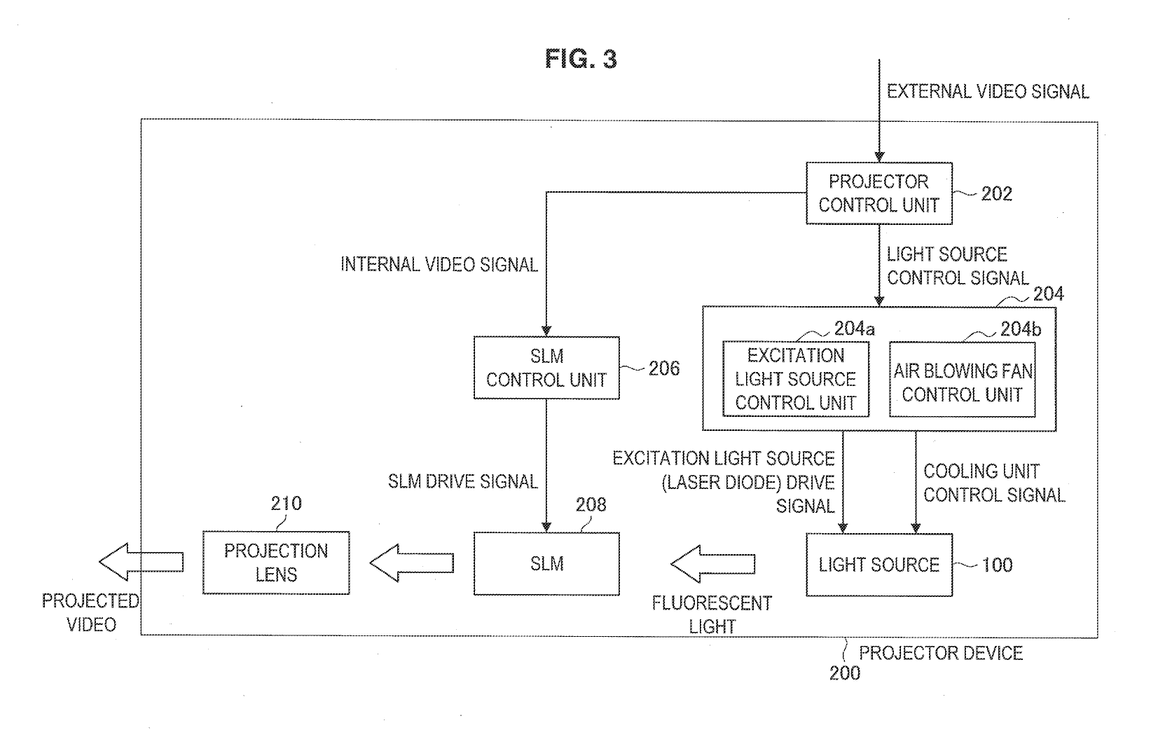

Next, a projector device 200 which employs the light source device 100 will be described with reference to FIG. 3. FIG. 3 is a schematic diagram showing a structure of the projector device 200. As shown in FIG. 3, the projector device 200 includes a projector control unit 202, a light source drive control unit 204, the light source device 100, an SLM control unit 206, a spatial light modulator (SLM) 208, and a projection lens 210.

An external input video signal is input to the projector control unit 202. Thereafter, the projector control unit 202 outputs, to the light source drive control unit 204, a control signal for controlling the excitation light source 124 and the air blowing fan 114. The light source drive control unit 204, which includes an excitation light source control unit 202a and an air blowing fan control unit 202b, controls the excitation light source 124 and the air blowing fan 114 based on the control signal.

The projector control unit 202 also outputs an internal video signal to the SLM control unit 206. The SLM control unit 206 drives the SLM 208 to modulate light from the light source device 100 based on the internal video signal. The light modulated by the SLM 208 is projected outward using the projection lens 210.

The SLM 208 may be a liquid crystal panel formed of a liquid crystal material, or a MEMS device having the same number of small minors as there are pixels, etc.

[3. Control of Light Source Device and SLM]

Next, details of how the light source device 100 and the SLM 208 are controlled based on an external video signal will be described. Moving image video signals include dark scenes and light scenes. If, for dark scenes, light entering the SLM 208 is reduced and the signal level of a video signal input to the SLM 208 is amplified, dark scenes become darker and therefore contrast perceived by the viewer increases.

Therefore, the projector control unit 202 analyzes the external video signal, and when the video contains a dark scene, reduces the luminance of the light source device 100, and amplifies the signal level of the video signal input to the SLM 208. It may be determined whether or not the video contains a dark scene, for example, by determining whether or not the luminance of a lightest area in the screen is not more than 50% of the maximum possible luminance.

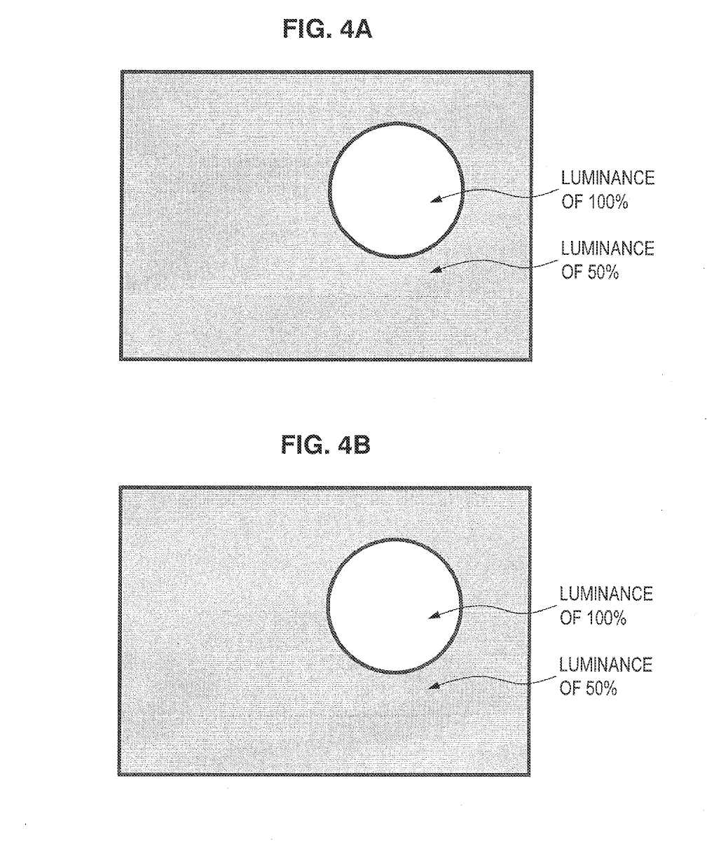

FIGS. 4A and 4B are schematic diagrams showing screens which are obtained when none of the light source device 100 and the SLM 208 is controlled based on an external video signal. FIG. 4A shows an internal video signal. FIG. 4B shows an external video signal. It is assumed that, as shown in FIG. 4B, the external input video signal contains a portion having a luminance of 100% and a portion having a luminance of 50%. When the light of the light source device 100 is not reduced, the SLM 208 may be driven, assuming that the internal video signal of FIG. 4A is almost the same as the external video signal.

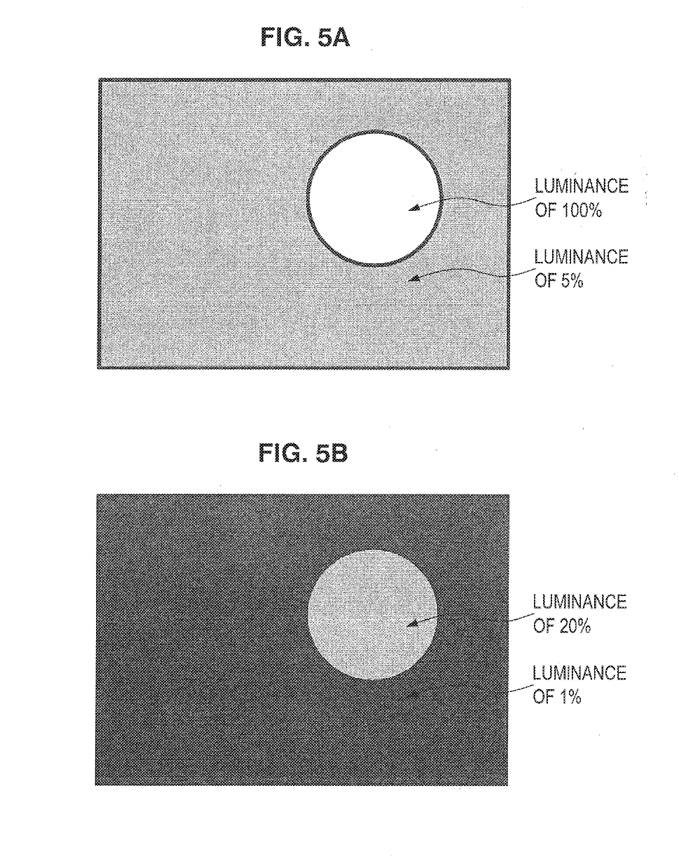

FIGS. 5A and 5B are schematic diagrams showing screens which are obtained when the light source device 100 and the SLM 208 are controlled based on an external video signal. FIG. 5A shows an internal video signal. FIG. 5B shows an external video signal. Here, it is assumed that, as shown in FIG. 5B, the external input video signal contains a portion having a luminance of 20% and a portion having a luminance of 1%. Because the highest luminance of the external video signal is 20%, the light of the light source device 100 is reduced to ⅕(=20/100). On the other hand, it is assumed that, as shown in FIG. 5A, the level of the internal video signal is almost 5(=100/20) times as high as the level of the external input video signal. Therefore, the SLM 208 is driven to provide a luminance which is 5 times as high. Light emitted by the light source device 100 toward the SLM 208 has a luminance which is ⅕ times as high. As a result, the luminance of a video projected by the projection lens 210 is almost the same as that indicated by the external input video signal.

In this case, the reproducibility of a low-gray-level video signal can be significantly improved. If the SLM 208 can be driven only within the range of 1% to 100%, then when, as shown in FIGS. 5A and 5B, the light of the light source device 100 is not reduced, the lowest gray level which can be displayed is 1%. However, if the light of the light source device 100 is reduced to ⅕, the lowest gray level that can be reproduced is 0.2% because the SLM 208 can be driven to provide a luminance which is 5 times as high. In general, a low-gray-level video often represents a scene which is dark throughout the entire screen, and therefore, the above control can significantly improve the reproducibility of low gray levels in a dark scene.

Thus, when a video is viewed under a dark environment, the luminance output of the light source device 100 may be reduced to provide a darker video scene, whereby contrast perceived by the viewer can be increased. This control may be performed by the user's control.

When instructed to reduce the luminance output of the light source device 100, the projector control unit 202 controls the light source drive control unit 204 so that the output of the excitation light source 124 is reduced, and at the same time, the cooling air of the air blowing fan 114 is reduced. As a result, the excitation light source control unit 202a and the air blowing fan control unit 202b of the light source drive control unit 204 control the excitation light source 124 and the air blowing fan 114 based on a control signal.

As described above, the projector control unit 202 determines the luminance level of an external input video signal, and for dark video scenes, outputs a control signal to the light source drive control unit 204 so that the excitation light output of the excitation light source 124 is reduced. The projector control unit 202 also outputs to the SLM control unit 206 an internal video signal which is obtained by amplifying the luminance level of the external video signal.

In this case, the light source drive control unit 204 adjusts the amount of a current of the excitation light source 124 to decrease the excitation light output of the excitation light source 124. The amount of heat generated by the excitation light source 124 decreases, and at the same time, the reduced excitation light also causes a decrease in the amount of heat generated by the fluorescent member 118a. As a result, the life of each laser diode 124a of the excitation light source 124 can be extended.

For dark scenes in the video signal, the light source drive control unit 204 also outputs a cooling control signal to the air blowing fan 114 to control the air blowing fan 114 in the light source device 100 so that cooling air is reduced. As a result, noise such as wind noise etc. caused by the air blowing fan 114 is reduced, and power consumption can be reduced. Also, the life of the air blowing fan 114 can be extended. Therefore, a laser diode, an LED, etc. may be used as the excitation light source 124, and by varying the drive current, the excitation light output can be easily varied, and therefore, the fluorescent light can be varied. Therefore, by reducing the excitation light when the fluorescent light of the solid-state light source is reduced, the amount of heat generated by the excitation light source 124 can be reduced, and the projector device 200 can be quieted.

When the excitation light output of the excitation light source 124 is reduced, the temperatures of the disc-shaped base plate 118 and the fluorescent member 118a also decrease. In this embodiment, the single air blowing fan 114 can cool both the excitation light source 124 and the fluorescent member 118a. As a result, it is advantageous to control only the air blowing fan 114. Therefore, reliable cooling can be achieved by a simple process, compared to when the light source device 100 and the fluorescent member 118a are separately controlled.

[Other Example Structures of Light Source Device]

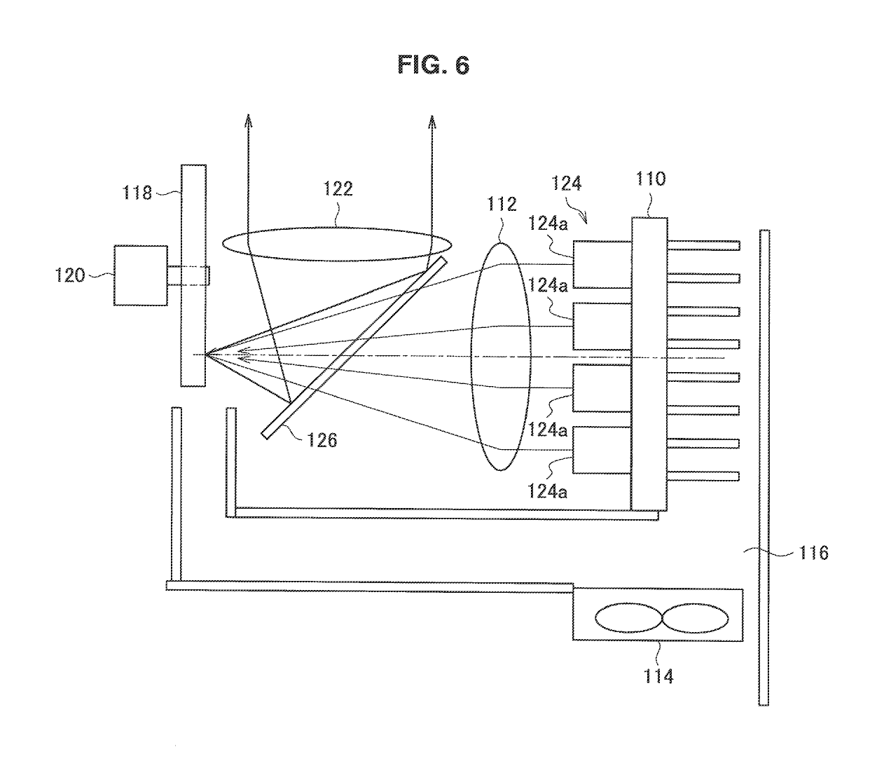

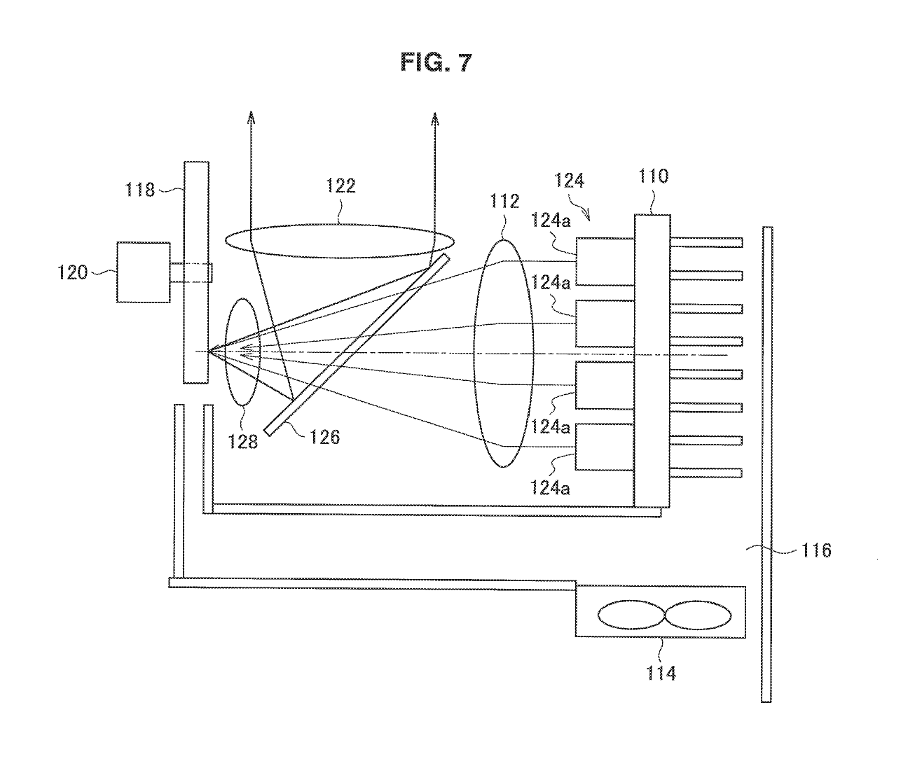

Next, another example structure of the light source device 100 will be described. FIG. 6 shows a structure in which fluorescent light generated by excitation light condensed on the fluorescent member 118a of the disc-shaped base plate 118 is reflected toward the excitation light source 124, and then travels toward the excitation light source 124. Specifically, a surface of the disc-shaped base plate 118 is formed to have a mirror surface of aluminum etc., and the fluorescent member 118a is formed on the surface of the disc-shaped base plate 118, and therefore, the fluorescent light is allowed to be reflected toward the excitation light source 124. In this case, a separation mirror 126 for separating the fluorescent light from the excitation light is provided in the middle of the optical system for condensing the excitation light. The excitation light has a blue color. When the fluorescent member is formed of a YAG material, the fluorescent light has a yellow color. When the excitation light and the fluorescent light have different wavelength bands, a dichroic minor etc. is used as the separation mirror 126. As a result, the excitation light passes through the separation mirror 126 to reach the fluorescent member 118a, and the fluorescent light is reflected by the separation mirror 126 and is then condensed by a fluorescent light condensing lens 122. Therefore, the excitation light and the fluorescent light can be separated from each other. FIG. 7 shows a variation of the structure of FIG. 6 in which a lens 128 is provided between the disc-shaped base plate 118 and the separation mirror 126. The lens 128 functions as an excitation light condensing lens for the excitation light traveling toward the fluorescent member 118a, and as a fluorescent light condensing lens for the fluorescent light traveling from the fluorescent member 118a toward the separation minor 126. Thus, a portion of the excitation optical system for condensing the excitation light may also function as a portion of the fluorescent light condensing lens for condensing the fluorescent light.

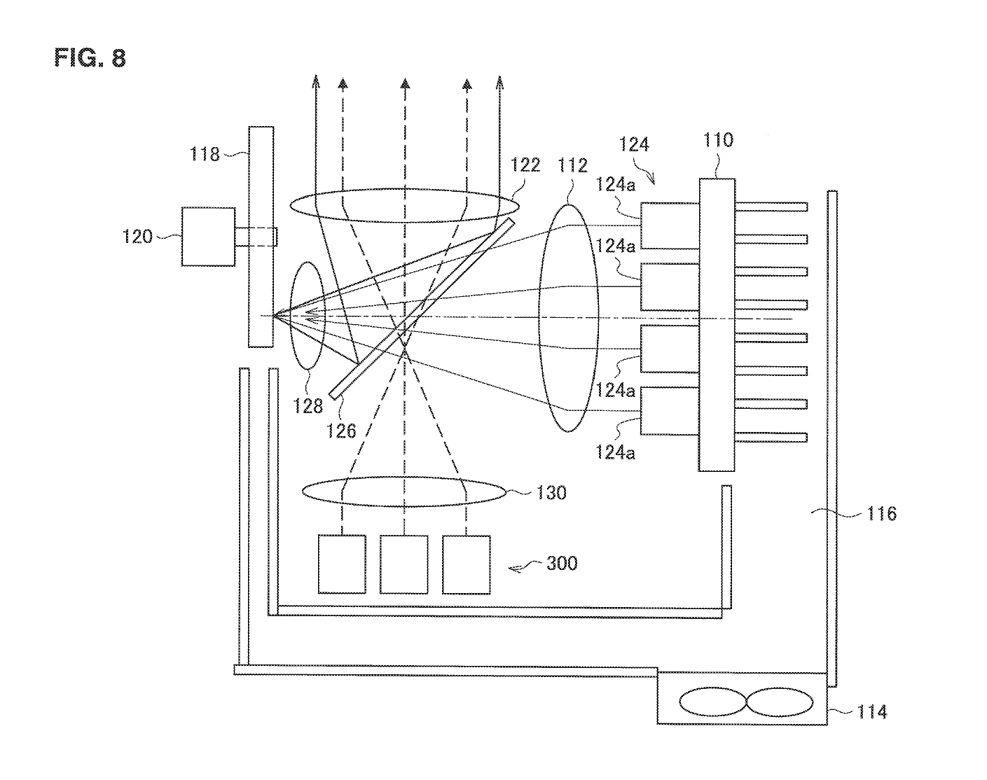

FIG. 8 shows a variation of the structure of FIG. 7 in which a blue light source 300 is additionally provided as a second light source. When the fluorescent member 118a is formed of a YAG material, the fluorescent light has a yellow color. Blue light emitted from the blue light source 300 is condensed by a blue light condensing lens 130, and then passes through the separation mirror 126. The blue light enters the fluorescent light condensing lens 122, along with the fluorescent light. As a result, white light can be emitted from the fluorescent light condensing lens 122.

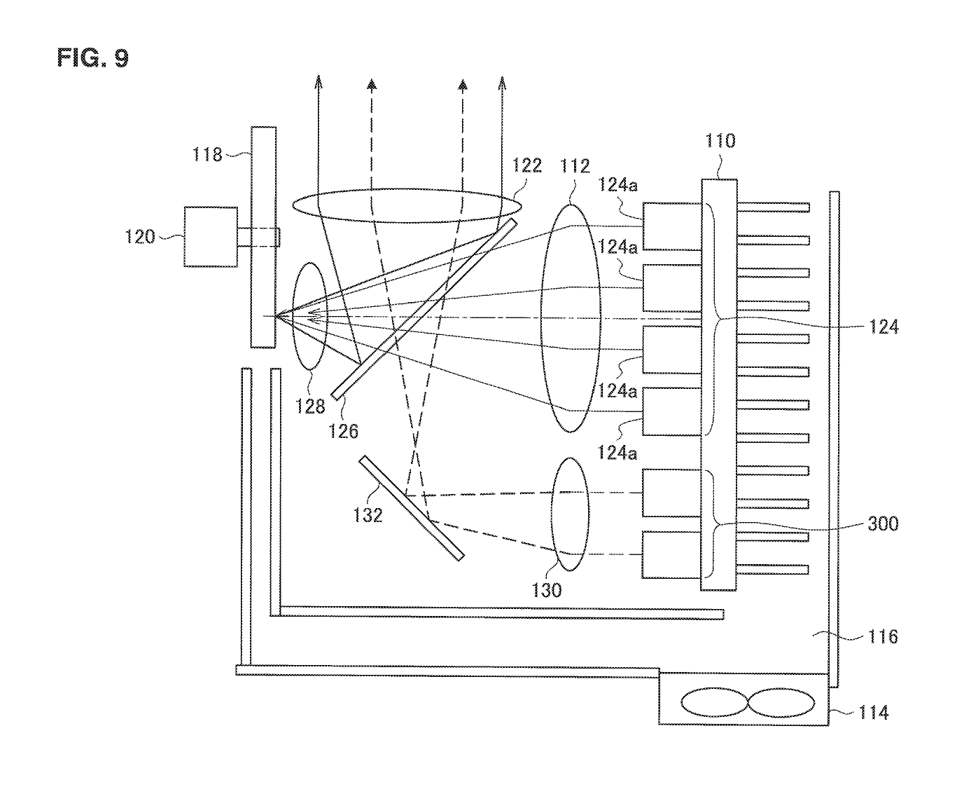

FIG. 9 shows a variation of the structure of FIG. 8 in which, as with the excitation light source 124, the blue light source 300 is connected to the heat sink 110. As a result, the excitation light source 124 and the blue light source 300 can be cooled by the same heat sink 110, resulting in an improvement in cooling efficiency and savings in space.

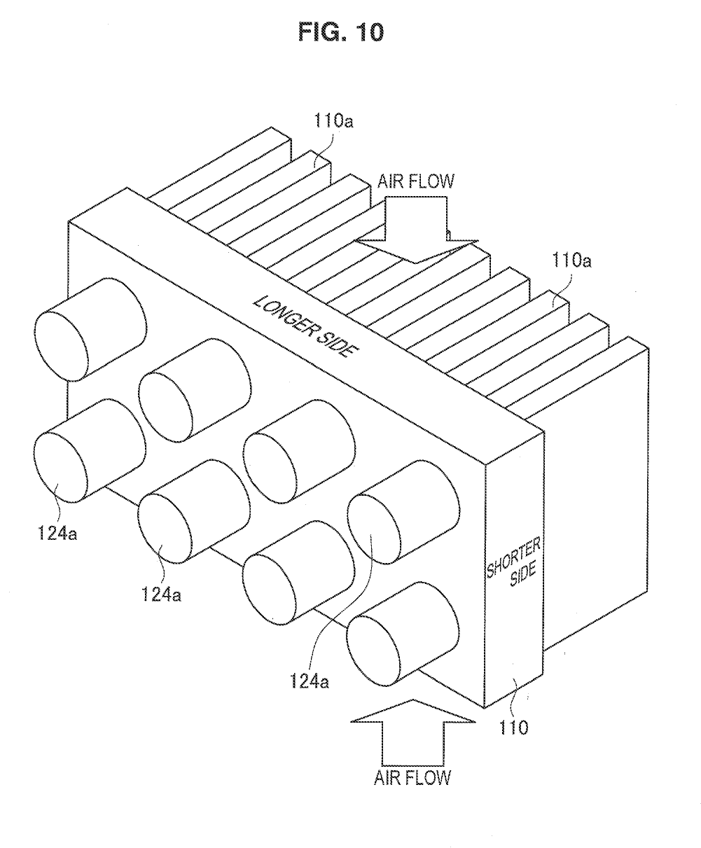

FIG. 10 is a schematic diagram showing a structure of the heat sink 110. As shown in FIG. 10, the laser diodes 124a included in the excitation light source 124 are provided on the front side of the heat sink 110. A plurality of fins 110a for cooling are provided on the back side of the heat sink 110. As shown in FIG. 10, cooling air sent by the air blowing fan 114 flows in the same direction as a longitudinal direction in which the fins 110a are extended. As a result, the cooling efficiency of the heat sink 110 can be improved.

As shown in FIG. 10, when the laser diodes 124a of the excitation light source 124 are arranged in a two-dimensional surface, it is desirable that the cooling air from the air blowing fan 114 enter the heat sink from a longer side of the two-dimensional array of the laser diodes 124a and then flow in a direction along a shorter side of the array. When the cooling air cools the heat sink 110, the temperature of the cooling air gradually increases as the cooling air flows along the fins 110a. Therefore, if the cooling air flows along the short side direction, the difference in cooling between areas of the heat sink 110 can be reduced to the extent possible.

Therefore, as described above, according to this embodiment, the single air blowing fan 114 cools the excitation light source 124 and the disc-shaped base plate 118, and therefore, the excitation light source 124 and the disc-shaped base plate 118 can be cooled together using a simple structure.

For dark video scenes, the excitation light output of the excitation light source 124 is reduced by the light source drive control unit 204, and at the same time, the SLM 208 is controlled using an internal video signal which is obtained by amplifying the luminance level of an external video signal. As a result, the excitation light output of the excitation light source 124 is reduced, and at the same time, the amount of heat generated by the fluorescent member 118a can be reduced by the reduced excitation light. Therefore, the amount of cooling by the cooling fan can be reduced.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.
(1) A projection-type display device including:

an excitation light source configured to emit excitation light;

a fluorescent member configured to emit fluorescent light when the excitation light from the excitation light source is condensed;

a heat sink connected to the excitation light source;

a single air blowing fan configured to cool the heat sink and the fluorescent member together; and

an excitation light source control unit configured to control an output of the excitation light source, depending on a luminance level of an external video signal.
(2) The projection-type display device according to (1), further including:

an air blowing fan control unit configured to change an amount of air sent by the air blowing fan, depending on the output of the excitation light source.
(3) The projection-type display device according to (1), further including:

a duct configured to divide cooling air of the air blowing fan into portions which are sent to the heat sink and the fluorescent member.
(4) The projection-type display device according to (1), wherein

the excitation light source includes a plurality of laser diodes, and

the plurality of laser diodes are arranged in a two-dimensional array on the heat sink, and cooling air from the air blowing fan flows through the array from a longer side of the array in a direction along a shorter side of the array.
(5) The projection-type display device according to (1), further including:

a spatial light modulator configured to receive the fluorescent light.
(6) The projection-type display device according to (5), further including:

a spatial light modulator control unit configured to control drive of the spatial light modulator, depending on the output of the excitation light source.
(7) The projection-type display device according to (1), further including:

a light source configured to emit light having a wavelength different from a wavelength of the fluorescent light.
(8) The projection-type display device according to (7), wherein

the projection-type display device emits the fluorescent light and the light having the wavelength different from the wavelength of the fluorescent light together.
(9) The projection-type display device according to (7), wherein the light source is connected to the heat sink.
(10) The projection-type display device according to (1), further including:

an excitation light condensing optical system configured to condense the excitation light from the excitation light source to a substantially identical portion of a surface of the fluorescent member.
(11) The projection-type display device according to (1), further including:

a fluorescent light condensing optical system configured to condense the fluorescent light emitted from the fluorescent member.
(12) The projection-type display device according to (10), further including:

a fluorescent light condensing optical system configured to condense the fluorescent light emitted from the fluorescent member,

wherein a portion of the excitation light condensing optical system serves as a portion of the fluorescent light condensing optical system.
(13) The projection-type display device according to (11), wherein the fluorescent light condensing optical system condenses the fluorescent light emitted from a surface of the fluorescent member on which the excitation light is condensed.
(14) A method for controlling a projection-type display device, wherein

the projection-type display device includes
an excitation light source configured to emit excitation light,
a fluorescent member configured to emit fluorescent light when the excitation light from the excitation light source is condensed,
a heat sink connected to the excitation light source, and
a single air blowing fan configured to cool the heat sink and the fluorescent member together, and

the method includes:
controlling an output of the excitation light source, depending on a luminance level of an external video signal; and
controlling an amount of air sent by the air blowing fan, depending on the output of the excitation light source.

What is claimed is:

1. A projection-type display device comprising:
an excitation light source configured to emit excitation light;
a fluorescent member configured to emit fluorescent light when the excitation light from the excitation light source is condensed;
a heat sink connected to the excitation light source;
a single air blowing fan configured to cool the heat sink and the fluorescent member together; and
an excitation light source control unit configured to control an output of the excitation light source, depending on a luminance level of an external video signal.

2. The projection-type display device according to claim 1, further comprising:
an air blowing fan control unit configured to change an amount of air sent by the air blowing fan, depending on the output of the excitation light source.

3. The projection-type display device according to claim 1, further comprising:
a duct configured to divide cooling air of the air blowing fan into portions which are sent to the heat sink and the fluorescent member.

4. The projection-type display device according to claim 1, wherein
the excitation light source includes a plurality of laser diodes, and
the plurality of laser diodes are arranged in a two-dimensional array on the heat sink, and cooling air from the air blowing fan flows through the array from a longer side of the array in a direction along a shorter side of the array.

5. The projection-type display device according to claim 1, further comprising:
a spatial light modulator configured to receive the fluorescent light.

6. The projection-type display device according to claim 5, further comprising:
a spatial light modulator control unit configured to control drive of the spatial light modulator, depending on the output of the excitation light source.

7. The projection-type display device according to claim 1, further comprising:
a light source configured to emit light having a wavelength different from a wavelength of the fluorescent light.

8. The projection-type display device according to claim 7, wherein
the projection-type display device emits the fluorescent light and the light having the wavelength different from the wavelength of the fluorescent light together.

9. The projection-type display device according to claim 7, wherein
the light source is connected to the heat sink.

10. The projection-type display device according to claim 1, further comprising:
an excitation light condensing optical system configured to condense the excitation light from the excitation light source to a substantially identical portion of a surface of the fluorescent member.

11. The projection-type display device according to claim 1, further comprising:
a fluorescent light condensing optical system configured to condense the fluorescent light emitted from the fluorescent member.

12. The projection-type display device according to claim 10, further comprising:
a fluorescent light condensing optical system configured to condense the fluorescent light emitted from the fluorescent member,
wherein a portion of the excitation light condensing optical system serves as a portion of the fluorescent light condensing optical system.

13. The projection-type display device according to claim 11, wherein
the fluorescent light condensing optical system condenses the fluorescent light emitted from a surface of the fluorescent member on which the excitation light is condensed.

14. A method for controlling a projection-type display device, wherein
the projection-type display device includes
an excitation light source configured to emit excitation light,
a fluorescent member configured to emit fluorescent light when the excitation light from the excitation light source is condensed,
a heat sink connected to the excitation light source, and
a single air blowing fan configured to cool the heat sink and the fluorescent member together, and
the method comprises:
controlling an output of the excitation light source, depending on a luminance level of an external video signal; and
controlling an amount of air sent by the air blowing fan, depending on the output of the excitation light source.
